(19) United States
(12) Patent Application Publication
(10) Pub. No.: US 2005/0079266 A1
(43) Pub. Date: Apr. 14, 2005

(54) Culinary base and method for the preparation of a ready-cooked dish or a flavored drink

(76) Inventors: Jean-Marie Samec, Villeurbanne (FR); Frederic Derbesy, Fuveau (FR)

Correspondence Address: OLIFF & BERRIDGE, PLC, P.O. BOX 19928, ALEXANDRIA, VA, 22320, US

(21) Appl. No.: 10/507,125

(22) PCT Filed: Mar. 11, 2003
(86) PCT No.: PCT/FR03/00780

(30) Foreign Application Priority Data
Mar. 11, 2002 (FR) 023500
Dec. 3, 2002 (FR) 0215206

(51) Int. Cl. A23C 1/00

(52) U.S. Cl. 426/580

(57) ABSTRACT

The culinary base comprises at least 75% of proteins by dry weight relative to the final dry weight of said base, lipids and carbohydrates. To prepare a ready-cooked dish or a flavored drink, at least one raw, pre-cooked, cooked or further-processed food is available, and said foods are mixed with the culinary base.

The invention falls within the field of dietetics, and more particularly within that of high-protein diets, in particular in humans.

It is known that too great a consumption of carbohydrates and of lipids results in the formation by the body of fat stores, and therefore engenders excess weight. A reduction in carbohydrate and lipid intake forces the body to convert absorbed proteins but, if the intake thereof is insufficient, the body will draw on the muscle mass, causing gradual loss thereof.

By virtue of a high intake of proteins and a low intake of carbohydrates and lipids, the aim of high-protein diets is thus weight loss with maintenance of muscle mass, the body consuming the carbohydrates and lipids, accumulated in the form of stores, and the ingested proteins.

In the context of high-protein diets, high-protein snacks or high-protein products intended for special medical purposes are known, which are ready-to-eat food preparations in the form of cream or in the form of powder to be diluted in water, which replace a meal.

Five classes of preparations exist: dessert, soup, omelette, flan, crepes (or pancake, loaf) available in various flavors. Within each class, the preparations are not varied. For example, the sweet preparations are limited to the vanilla, coffee or chocolate flavor. The savory preparations are, themselves, generally available in the form of dehydrated soup.

The solutions have many disadvantages, first because, due to the fact that they replace meals, they deprive the body of any intake of fresh foods. Then, the poor diversity of the flavors consumed during the diet, which are in addition constructed or reconstituted flavors, results in the consumer rapidly becoming tired of them. Finally, they cause the consumer to lose the habit of having a real meal.

The applicants have developed a preparation, hereinafter referred to as culinary base, for optionally cooking, and for accompanying foods, in accordance with a high-protein diet, namely high intake of proteins and low intake of carbohydrates and lipids.

Thus, a first subject of the invention is a culinary base comprising at least 75%, advantageously at least 80%, of proteins by dry weight relative to the final dry weight of said base, lipids and carbohydrates.

Before disclosing in greater detail the subjects of the invention, the definition of terms used in the description and the claims is given hereinafter.

The term “culinary base” is understood to mean a system for directly accompanying, or for cooking and accompanying, a food, said system having an essentially neutral flavor, and which can be seasoned, in particular salted, spiced, sweetened, and which, by virtue of its culinary function, can substitute for all the basic ingredients required to prepare the food, such as butter, flour, milk, cream, etc. This culinary function is illustrated in particular by a binding and emulsifying capacity of said base.

According to the invention, the terms “protein” and “protide” will be used without distinction to denote an amino acid, a peptide, a polypeptide, a protein and any substance, the hydrolysis of which produces at least one amino acid, one peptide, one polypeptide or one protein, and mixtures thereof.

A food is of animal or plant origin and constitutes, in the method of the invention, the “theme” or “subject” of the flavored drink or of the ready-cooked dish that the culinary base will make it possible to prepare. Thus, it is the presentation of this food, for example in the form of a drink or of a cream, the reheating thereof or the cooking thereof, by means of the culinary base, which results in said flavored drink or said ready-cooked dish.

The food(s) according to the invention may be in the raw, pre-cooked or cooked state. When the food is partially or completely cooked, the cooking thereof is preferably carried out in the absence of fats, for example with water or with steam, so as not to provide any needless lipid intake, the culinary base providing, on its own, the minimum intake required for preparing the ready-cooked dish.

The term “further-processed food” is understood to mean a food which has undergone one or more treatments, possibly on an industrial scale, in particular for its conversion into a consumable food, such as extraction, roasting, etc. By way of example, a further-processed food is cocoa powder, coffee.

Preferred characteristics of a culinary base according to the invention, which should be considered alone or in combination, are disclosed hereinafter.

The proteins are advantageously chosen from heat-resistant proteins, in particular from casein, albumin and globulin from milk.

The carbohydrates of the culinary base will be chosen from rapidly absorbed assimilable carbohydrates, slowly absorbed assimilable carbohydrates, and fibers.

A culinary base of the invention may also comprise vitamins, trace elements and mineral salts. The vitamins are in particular those chosen form vitamins A, B1, B2, B5, B6, B9, B12, C, D, D2, E, H, K1 and PP, the trace elements are in particular those chosen from iodine, fluorine, iron, zinc, bromine, aluminum, silicon, copper, manganese, selenium, chromium, molybdenum, phosphorus and cobalt, and the mineral salts are in particular chosen from calcium salts, sodium salts, potassium salts and magnesium salts, and in particular the chlorides and the carbonates. The proportions thereof are of the order of 10% of the Recommended Daily Intakes (RDIs).

A culinary base as defined above is advantageously provided in the form of a powder, of tablets or of a cream. Such presentation forms make it possible to readily and precisely take a predetermined amount of culinary base suitable for the amount of food to be prepared. The consistency of the cream is variable; it can vary between the consistency of liquid cream from milk and thick cream, such as those which are found commercially.

According to a preferred variant of the invention, a culinary base comprises at least 75%, or even at least 80%, of milk proteins by dry weight relative to the final dry weight of said base, it is provided in the form of a cream and the carbohydrates comprise lactose only in at most trace amounts and/or the lipids comprise cholesterol only in at most trace amounts.

Thus, substantially free of lactose, it is particularly suitable for consumers who suffer from lactose intolerance.

It may also comprise at least one emulsifier and/or at least one stabilizer and/or at least one thickener. A suitable emulsifier is chosen from polyphosphates, preferably in a proportion of approximately 0.3 g per 10 g of protein by dry weight. A suitable thickener is chosen from alginates, preferably in a proportion of approximately 0.3 to 0.4 g per 10 g of protein by dry weight. Xanthan is advantageously used as stabilizer and/or thickener.

When it is provided in the form of cream, in accordance with the preferred variant, it comprises in g (unless otherwise indicated) per 100 of cream:

| | |
|---|---|
| Milk proteins | 13 |
| Assimilable carbohydrates | less than 1.2 |
| Lipids | less than 0.2 |
| Mineral salts | 10% of the RDIs^{*} |
| Vitamins | 10% of the RDIs^{*} |
| Xanthan | 0.2 |
| Water | 83 |

*Recommended Daily Intakes

Another subject of the invention is a method for the preparation of a ready-cooked dish or of a flavored drink, comprising the following steps:
at least one raw, pre-cooked, cooked or further-processed food is provided, and
said foods are mixed with a culinary base of the invention as defined above; said culinary base is advantageously in the form of cream.

If the base is in the form of a powder, and before it is used, in particular before it is mixed with said food(s), it is dissolved in water, or any preferably low-calorie liquid, such as the water from cooking vegetables, according to a dose which can vary as a function of the dish or drink to be prepared. Thus, if a soup or a drink is prepared, said amount of culinary base will be diluted in a volume of water greater than that which would be selected if the base was used to prepare a vegetable gratin, for example.

The culinary base according to the invention withstands high temperatures, and the heating thereof at temperatures for cooking foods does not engender any toxic products or products liable to affect the value of the diet. It can be heated, before it is mixed with said food(s), and/or it is the whole mix resulting from the mixing of said food(s) with the culinary base which is heated.

To prepare a ready-cooked dish, said food(s) will advantageously be chosen from vegetables, meats, fish, fruit, and mixtures thereof. In the context of a strict diet, low-calorie foods will preferably be selected.

To prepare a flavored drink, said food(s) may be chosen from powdered chocolate, from coffee and from fruit juices.

Another subject of the invention is a ready-cooked dish or a flavored drink which can be obtained by means of a method as described above.

The invention also relates to a culinary base comprising a proportion of at least 75% of proteins by dry weight relative to the final dry weight of said base, and the remainder in lipids and in carbohydrates.

Examples of composition and of uses of culinary bases according to the invention are given hereinafter, and from which the advantages of the invention will emerge.

### EXAMPLE 1

The culinary base is a powder and comprises proteins in a proportion by dry weight, relative to the dry weight of the base, of 75.3%, said proteins being chosen from milk proteins and soybean proteins, glucose syrup, salt, xanthan gum and magnesium carbonate.

The exact composition in grams of this base, per 100 g of the base by dry weight, is as follows:

| | |
|---|---|
| Proteins | 75.3 |
| Assimilable carbohydrates | 9.2 |
| Lipids | 1.5 |
| Fibers | 1.0 |
| Minerals | 8.5 |
| Water content | 4.5 |

This base is advantageously used for preparing soups using fresh vegetables, such as leeks or celery, in a proportion of approximately 20 g per 200 ml of water or of vegetable broth.

A soup comprising, by dry weight relative to the total dry weight of the soup, 80% of proteins, 5% of lipids and 15% of carbohydrates is obtained.

The soup obtained is a velouté which, while having the creaminess and the flavor of a soup prepared with fats, in particular cream, is low in calories, approximately 32 kcal per 100 g of soup by dry weight.

This base can also be used to obtain a béchamel sauce.

### EXAMPLE 2

The culinary base is a powder and comprises proteins in a proportion, by dry weight relative to the dry weight of the base, of 75.6%, said proteins being chosen from milk proteins, aspartame, xanthan gum and magnesium carbonate.

The exact composition in grams of this base, per 100 g of the base by dry weight, is as follows:

| | |
|---|---|
| Proteins | 75.6 |
| Assimilable carbohydrates | 13.1 |
| Lipids | 1.0 |
| Fibers | 0.9 |
| Minerals | 4.8 |
| Water content | 4.6 |

This base is advantageously used for preparing a chocolate-flavored cream, in a proportion of approximately 20 g per 200 ml of water and approximately 50 g of defatted cocoa powder.

A chocolate-flavored cream comprising, by dry weight relative to the total dry weight of the cream, 83% of proteins, 9% of lipids and 8% of carbohydrates is obtained. It is low in calories, approximately 14 kcal per 100 g of cream by dry weight.

### EXAMPLE 3

The culinary base is a powder and comprises proteins in a proportion, by dry weight relative to the dry weight of the base, of 87%, said proteins being chosen from milk proteins and egg proteins, flavoring and salt.

The exact composition in grams of this base, per 100 g of the base by dry weight, is as follows:

| | |
|---|---|
| Proteins | 75.1 |
| Assimilable carbohydrates | 3.6 |
| Fibers | 0.3 |
| Lipids | 7.1 |
| Minerals | 7.8 |
| Water content | 6.1 |

This base is advantageously used for preparing a vegetable terrine, in a proportion of approximately 20 g per 100 ml of water.

### EXAMPLE 4

The culinary base is a powder and comprises proteins in a proportion, by dry weight relative to the dry weight of the base, of 75.4%, said proteins being chosen from milk proteins and egg proteins, wheat flour, chemical yeast and magnesium carbonate.

The exact composition in grams of this base, per 100 g of the base by dry weight, is as follows:

| | |
|---|---|
| Proteins | 75.4 |
| Assimilable carbohydrates | 10.2 |
| Fibers | 0.4 |
| Lipids | 3.8 |
| Minerals | 4.2 |
| Water content | 6.0 |

This base is advantageously used for obtaining, by cooking, low-calorie crepes.

### EXAMPLE 5

The culinary base is a cream and is prepared as follows.

94.75 g of commercially available heat-resistant milk proteins, 1 g of xanthan, 0.50 g of a vitamin composition (commercially available), 0.50 g of a trace element composition (Fe, Zn, I, Se, Mn and Cu) (commercially available), 0.60 g of calcium carbonate, 0.60 g of sodium chloride and 2.05 g of potassium chloride are dry-mixed in a container. This mixture is poured into 500 g of water, brought to a temperature of 90° C. beforehand, with vigorous stirring of the Ultraturrax type. In a jacketed vessel, the mixture thus obtained is brought to 90° C. for 5 minutes and then allowed to cool to 70° C.

The mixture is introduced into an appropriate packaging, for example a metal tin, said packaging is sealed and then immediately immersed in a water bath at 90° C. to remain there for one hour, in order to sterilize the cream. The packaged cream is then cooled for one hour in a bath of cold running water.

The cream thus obtained has the appearance and the viscosity of thick cream, which, in the case of a high-protein diet, it completely replaces.

1-21. (canceled)

22. A dietetic culinary base for obtaining a food preparation, said base comprising at least 75% of proteins by dry weight relative to the final dry weight of said base, lipids and carbohydrates, in a small amount, characterized in that it is in the form of cream, in that it has a neutral flavor and in that it contributes to obtaining the food preparation.

23. The culinary base as claimed in claim 22, characterized in that the proteins are chosen from heat-resistant proteins or proteins rendered heat resistant.

24. The culinary base as claimed in claim 23, characterized in that the heat-resistant proteins are chosen from casein, albumin and globulin from milk.

25. The culinary base as claimed in claim 22, characterized in that the carbohydrates are chosen from rapidly absorbed assimilable carbohydrates, slowly absorbed assimilable carbohydrates, and fibers.

26. The culinary base as claimed in claim 22, characterized in that it also comprises vitamins, trace elements and mineral salts.

27. The culinary base as claimed in claim 26, characterized in that the vitamins are chosen from vitamins A, B1, B2, B5, B6, B9, B12, C, D, E, H and PP.

28. The culinary base as claimed in claim 26, characterized in that the trace elements are chosen from iodine, fluorine, iron, zinc, bromine, aluminum, silicon, copper, manganese, selenium, chromium, molybdenum, phosphorus, manganese and cobalt.

29. The culinary base as claimed in claim 26, characterized in that the mineral salts are chosen from calcium salts, sodium salts, potassium salts and magnesium salts, and in particular the chlorides and the carbonates.

30. The culinary base as claimed in claim 22, characterized in that the carbohydrates comprise only lactose only in at most trace amounts and/or the lipids comprise cholesterol only in at most trace amounts.

31. The culinary base as claimed in claim 30, characterized in that it also comprises at least one emulsifier and/or at least one stabilizer and/or at least one thickener.

32. The culinary base as claimed in claim 31, characterized in that it comprises in g (unless otherwise indicated) per 100 g of cream:

| | |
|---|---|
| Milk proteins | 13 |
| Assimilable carbohydrates | less than 1.2 |
| Lipids | less than 0.2 |
| Mineral salts | 10% of the RDIs (Recommended Daily |
| | Intakes) |
| Vitamins | 10% of the RDIs |
| Xanthan | 0.2 |
| Water | 83 |

33. The culinary base as claimed in claim 31, characterized in that it also comprises polyphosphates and/or alginates.

34. A method for obtaining a food preparation, characterized by the following steps:
at least one raw or pre-cooked food is provided,
said foods are mixed with a culinary base as claimed in claim 22, and, optionally,
said foods are cooked in the presence of the culinary base.

35. The method as claimed in claim 34, characterized in that said food(s) is (are) chosen from vegetables, meats, fish, fruit, and mixtures thereof.

36. A food preparation which can be obtained by means of a method as claimed in claim 34.
